(19) United States
(12) Patent Application Publication
(10) Pub. No.: US 2025/0392947 A1
(43) Pub. Date: Dec. 25, 2025

(54) INTERFERENCE-LIMITED TRANSMISSION FROM ACCESS POINTS

(71) Applicant: Telefonaktiebolaget LM Ericsson (publ), Stockholm (SE)

(72) Inventors: Ralf SCHUH, Lund (SE); Torbjörn ELFSTRÖM, Fjärås (SE); Thomas CHAPMAN, Solna (SE); Rafael PUERTA, Sundbyberg (SE)

(73) Assignee: Telefonaktiebolaget LM Ericsson (publ), Stockholm (SE)

(21) Appl. No.: 18/880,420

(22) PCT Filed: Jun. 27, 2023
(86) PCT No.: PCT/EP2023/067526

§ 371 Date: Dec. 31, 2024

(30) Foreign Application Priority Data
Jul. 4, 2022 (SE) 2230217-8

(51) Int. Cl. H04W 28/02; H04W 16/14; H04W 24/02

(52) U.S. Cl. CPC H04W 28/0236; H04W 16/14; H04W 24/02

(57) ABSTRACT

There is provided techniques for interference-limited transmission from access points in a communication network. Access point information is obtained. Traffic information is obtained. An estimate of interference per each grid point in a set of geographically spread grid points for the access points is obtained. Adjustments are specified to transmission settings of at least one of the access points based on an aggregate of the obtained estimates of interference for all the access points per each of the grid points. The adjustments are conditioned on a prescribed interference limit for the subset of the grid points and on the traffic information. Control commands defined by the specified adjustments are provided to the transmission settings towards the at least one of the access points.

### TECHNICAL FIELD

Embodiments presented herein relate to a method, a control node, a computer program, and a computer program product for interference-limited transmission from access points in a communication network.

### BACKGROUND

According to existing regulations, access points, for example providing network coverage in cellular wireless communication networks, have to fulfil protection criteria towards other systems, hereinafter denoted victim systems, or just victims for short, in the frequency band of operation or in adjacent frequency bands. This is in order to protect the victims from interference. Interference can be caused by blocking the victim receiver, or degrading the victim receiver sensitivity due to the limited selectivity of the victim receiver, etc.

The victim can be placed either below or above the horizon with respect to the access point. For example, if the antenna system of the cellular access point is placed in a cell tower, any victim located at ground level would be considered to be below the horizon with respect to the cellular access point, whereas a victim in the form of an airplane in flight or a satellite in orbit would be considered to be above the horizon with respect to the cellular access point. Further in this respect, the victim may either be movable (such as an airplane, a non-stationary satellite) or stationary (such as a geostationary satellite, a Fixed Satellite Service (FSS) device, or a Radio Astronomy Service (RAS) device).

The aggregated interference at the victim (i.e., the total interference from all access points within the victim receiver aperture) is usually of interest. The interference from many access points towards the victim is considered and from this a maximum power, or allowed unwanted emission limit, per individual sector can be calculated for the access points. Setting requirements per sector is a common approach used for radio frequency requirements when using advanced antenna systems (AASs), as for example disclosed in the document 3GPP TS 37.105 entitled “Active Antenna System (AAS) Base Station (BS) transmission and reception” version 17.6.0, and in the document 3GPP TS 38.104 entitled “NR; Base Station (BS) radio transmission and reception”, version 17.6.0. The limit per access point must be set conservatively assuming the worst case number of access points simultaneously transmitting. The activity/load in access points and user equipment in each sector is independent. This means that the sum of the interference towards a given victim will be from many interferers. In traditional techniques for mitigating interference often the worst case is assumed (e.g., maximum possible number of simultaneously active interferers), which results in tighter than necessary requirements for the access points. This because for the vast majority of the time, the activity factor for any given access point is lower than the maximum.

In further detail, for safety critical systems, in order to decide on interference limits, the accumulated interference from access points as seen at the victim is calculated for a typical deployment scenario and the probability of allowed interference above the victim receiver threshold is assessed. The selected scenario and underlying assumptions need to be conservative, since the interference may not exceed the limits at any time during live operation. During live operation, the probability of actual interference level over time and space depends on many factors, such as access point location, number of access points within the victim receiver coverage, network load, antenna configurations, and, in case of AASs, beamforming statistics. For safety critical systems, the interference is typically only allowed to be above the victim receiver threshold at most 2% (or even 1%) of the time and/or at most in 2% (or even 1%) of the space.

At some occasional points in time, all access points may reach an operating condition resulting in that all access points simultaneously operate close to the maximum interference towards the victim. If the distance between the access points and the victim is assumed to be larger than that between the access points themselves, the propagation loss is similar from each of the access points to the victim. The individual performance of each access point towards the victim will be based on regulations with respect to a worst case scenario with a probability of interference being limited to be above the victim receiver threshold at most 2% (or even 1%) of the time and/or at most in 2% (or even 1%) of the space. Although scenarios in which all access points are active and point their radiated power towards the victim are infrequent, in practice when considering very low interference probabilities, such scenarios need to be considered and the requirements on each individual access point need to be set based on this worst case scenario.

Examples of current technologies for interference suppression, or mitigation, will be summarized next.

Some technologies are based on independently limiting the amount of power, or unwanted emissions, from each individual access points, thus without any coordinated control of the aggregated interference towards victims from multiple access nodes. In case an assumption is made that there is not any relations between the instantaneous activity and beam direction of different access points with respect to the accumulated interference towards the victim, a result is that tighter than necessary restrictions are set for the access points in order to limit unwanted emissions. Another effect is that guard bands, and/or other types of margins, are selected to be larger than needed, etc.

Some technologies are based on progressively rolling out a network (i.e., adding one access point after another) in order to understand if interference caused by a newly added access point can cause a problem or not. At each stage in the roll-out, the accumulated interference towards the victims is monitored and observed to be compliant before moving to the next stage. This is a both lengthy and cumbersome process since an analysis needs to be performed for each access point added to the network.

### SUMMARY

An object of embodiments herein is to address at least some of the above disclosed issues in order to provide improved interference suppression, or mitigation, in a communication network.

According to a first aspect there is presented a method for interference-limited transmission from access points in a communication network. Each of the access points comprises an antenna system. The method is performed by a control node. The method comprises obtaining access point information indicative of: geographical deployment information for the access points, and transmission settings for the access points. The method comprises obtaining traffic information indicative of OTA traffic patterns of the access points. The OTA traffic patterns comprise OTA transmission patterns and any scheduling requests for user equipment served by the access points. The method comprises obtaining an estimate of interference per each grid point in a set of geographically spread grid points for the access points. The grid points are in line with and/or above a horizontal plane of the antenna systems of the access points. The method comprises obtaining a prescribed interference limit for at least a subset of the grid points. The method comprises specifying adjustments to the transmission settings of at least one of the access points based on an aggregate of the obtained estimates of interference for all the access points per each of the grid points. The adjustments are conditioned on the prescribed interference limit for said subset of the grid points and on the traffic information. The method comprises providing control commands defined by the specified adjustments to the transmission settings towards said at least one of the access points.

According to a second aspect there is presented a control node for interference-limited transmission from access points in a communication network. Each of the access points comprises an antenna system. The control node comprises processing circuitry. The processing circuitry being configured to cause the control node to obtain access point information indicative of: geographical deployment information for the access points, and transmission settings for the access points. The processing circuitry being configured to cause the control node to obtain traffic information indicative of OTA traffic patterns of the access points. The OTA traffic patterns comprise OTA transmission patterns and any scheduling requests for user equipment served by the access points. The processing circuitry being configured to cause the control node to obtain an estimate of interference per each grid point in a set of geographically spread grid points for the access points. The grid points are in line with and/or above a horizontal plane of the antenna systems of the access points. The processing circuitry being configured to cause the control node to obtain a prescribed interference limit for at least a subset of the grid points. The processing circuitry being configured to cause the control node to specify adjustments to the transmission settings of at least one of the access points based on an aggregate of the obtained estimates of interference for all the access points per each of the grid points. The adjustments are conditioned on the prescribed interference limit for said subset of the grid points and on the traffic information. The processing circuitry being configured to cause the control node to provide control commands defined by the specified adjustments to the transmission settings towards said at least one of the access points.

According to a third aspect there is presented a control node for interference-limited transmission from access points in a communication network. Each of the access points comprises an antenna system. The control node comprises an obtain module configured to obtain access point information indicative of: geographical deployment information for the access points, and transmission settings for the access points. The control node comprises an obtain module configured to obtain traffic information indicative of OTA traffic patterns of the access points. The OTA traffic patterns comprise OTA transmission patterns and any scheduling requests for user equipment served by the access points. The control node comprises an obtain module configured to obtain an estimate of interference per each grid point in a set of geographically spread grid points for the access points. The grid points are in line with and/or above a horizontal plane of the antenna systems of the access points. The control node comprises an obtain module configured to obtain a prescribed interference limit for at least a subset of the grid points. The control node comprises a specify module configured to specify adjustments to the transmission settings of at least one of the access points based on an aggregate of the obtained estimates of interference for all the access points per each of the grid points. The adjustments are conditioned on the prescribed interference limit for said subset of the grid points and on the traffic information. The control node comprises a provide module configured to provide control commands defined by the specified adjustments to the transmission settings towards said at least one of the access points.

According to a fourth aspect there is presented a computer program for interference-limited transmission from access points in a communication network, the computer program comprising computer program code which, when run on a control node, causes the control node to perform a method according to the first aspect.

According to a fifth aspect there is presented a computer program product comprising a computer program according to the fourth aspect and a computer readable storage medium on which the computer program is stored. The computer readable storage medium could be a non-transitory computer readable storage medium.

Advantageously, these aspects provide improved interference suppression, or mitigation, in a communication network compared to the above listed current technologies.

Advantageously, these aspects remove the need for additional, or baseline, interference and/or power limits for the access points as the interference will be controlled and limited.

Advantageously, the proposed method is not limited to interference mitigation for stationary ground-based victims whose exact locations are known to the access points.

Advantageously, the use of grid points enables the accumulated interference towards a moving or stationary victims to be calculated without knowing the actual position of the victim.

Advantageously, these aspects allow usage of the spectrum which otherwise is not useable due to strict protection requirements.

Advantageously, these aspects provide additional degrees of freedom with regards to parameters to be adjusted in comparison to techniques based on independently limiting the amount of power, or unwanted emissions, from each individual access point.

Advantageously, these aspects allow for less stringent requirement of unwanted emissions, or power restrictions, for individual access points towards the victim.

Advantageously, these aspects enable better utilization of the available headroom for adjusting emissions and/or power, thereby enabling improvements to throughput and/or user service quality in the communication network.

Advantageously, these aspects enable guard bands to be reduced, thereby increasing spectrum efficiency.

Advantageously, these aspects enable the size of interference controlled zones (e.g., around airports) to be reduced.

Advantageously, these aspects can be used as part of optimizing the power usage of the access points whilst still meeting interference conditions.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communications network according to embodiments;

FIG. 2 schematically illustrates a side view of beamformed transmission from an access point towards a user equipment according to an embodiment;

FIG. 3 schematically illustrates a top view of beamformed transmission from access points according to an embodiment;

FIG. 4 schematically illustrates a top view the grid points in FIG. 3.

FIG. 5 is a flowchart of methods according to embodiments;

FIG. 6 schematically illustrates three examples of adjustments of transmission settings according to embodiments;

FIG. 7 is a block diagram of a control node according to embodiments;

FIG. 8 is a schematic diagram showing functional units of a control node according to an embodiment;

FIG. 9 is a schematic diagram showing functional modules of a control node according to an embodiment;

FIG. 10 shows one example of a computer program product comprising computer readable storage medium according to an embodiment;

FIG. 11 is a schematic diagram illustrating a telecommunication network connected via an intermediate network to a host computer in accordance with some embodiments; and

FIG. 12 is a schematic diagram illustrating host computer communicating via a radio base station with a terminal device over a partially wireless connection in accordance with some embodiments.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

The wording that a certain data item or piece of information is obtained by a first device should be construed as that data item or piece of information being retrieved, fetched, received, or otherwise made available to the first device. For example, the data item or piece of information might either be pushed to the first device from a second device or pulled by the first device from a second device. Further, in order for the first device to obtain the data item or piece of information, the first device might be configured to perform a series of operations, possible including interaction with the second device. Such operations, or interactions, might involve a message exchange comprising any of a request message for the data item or piece of information, a response message comprising the data item or piece of information, and an acknowledge message of the data item or piece of information. The request message might be omitted if the data item or piece of information is neither explicitly nor implicitly requested by the first device.

The wording that a certain data item or piece of information is provided by a first device to a second device should be construed as that data item or piece of information being sent or otherwise made available to the second device by the first device. For example, the data item or piece of information might either be pushed to the second device from the first device or pulled by the second device from the second device. Further, in order for the first device to provide the data item or piece of information to the second device, the first device and the second device might be configured to perform a series of operations in order to interact with each other. Such operations, or interaction, might involve a message exchange comprising any of a request message for the data item or piece of information, a response message comprising the data item or piece of information, and an acknowledge message of the data item or piece of information. The request message might be omitted if the data item or piece of information is neither explicitly nor implicitly requested by the second device.

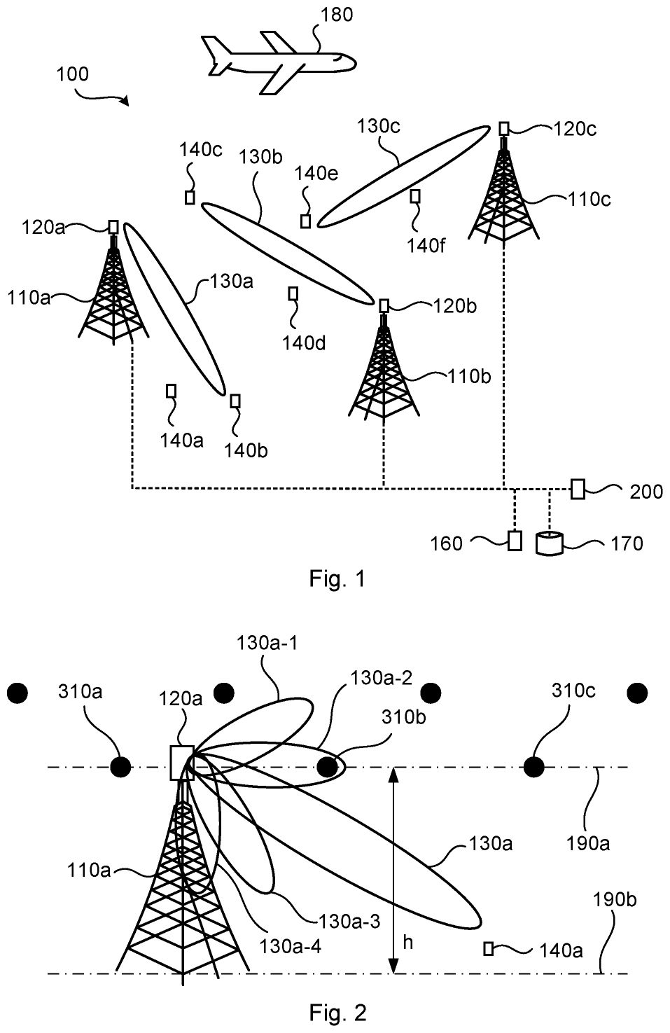

FIG. 1 is a schematic diagram illustrating a communication network 100 where embodiments presented herein can be applied. The communication network 100 comprises access points 110a, 110b, 110c. Each access point 110a:110c could be a (radio) access network node, radio base station, base transceiver station, node B (NB), evolved node B (eNB), gNB, integrated access and backhaul (IAB) node, repeater, or the like. Each access point 110a:110c is provided with its own antenna system 120a, 120b, 120c. The access points 110a:110c are, via the antenna systems 120a, 120b, 120c arranged for beamformed transmission towards served user equipment 140a, 140b, 140c, 140d, 140e, 140f. In FIG. 1 is schematically illustrated one beam 130a, 130b, 130c (as represented by its main lobe) for each of the access points 110a:110c. Each user equipment 140a:140f could be any of a portable wireless device, mobile station, mobile phone, handset, wireless local loop phone, smartphone, laptop computer, tablet computer, wireless modem, wireless sensor device, Internet of Things (IoT) device, network equipped vehicle, or the like.

A centralized scheduler 160 is configured to handle scheduling requests for the user equipment 140a:140b. In FIG. 1 is further illustrated a database 170 in which various types of information as collected from the access points 110a:110c, the user equipment 140a:140b, and the centralized scheduler 160 might be stored and accessed.

Radio transceiver, or receiver, device 180 is acting as a victim. In general terms, the term victim as used herein refers to any radio transceiver, or receiver, device whose radio performance (especially in terms of signal reception) might be degraded if the interference experienced by the radio transceiver, or receiver, device exceeds some threshold level. Interference as caused by the access points 110a:110c in the direction towards the victim should therefore be limited, or otherwise controlled. For this purpose a control node 200 is provided for enabling interference-limited transmission from the access points 110a:110c in the communication network 100.

In some examples, all access points 110a:110d are operated by one and the same mobile network operator (MNO). However, in other examples, different subsets of the access points are operated by different MNOs. The herein disclosed embodiments are not limited to the number of MNOs operating the access points. Neither are the herein disclosed embodiments limited to whether the access points are configured to operate in the same or in separated frequency bands.

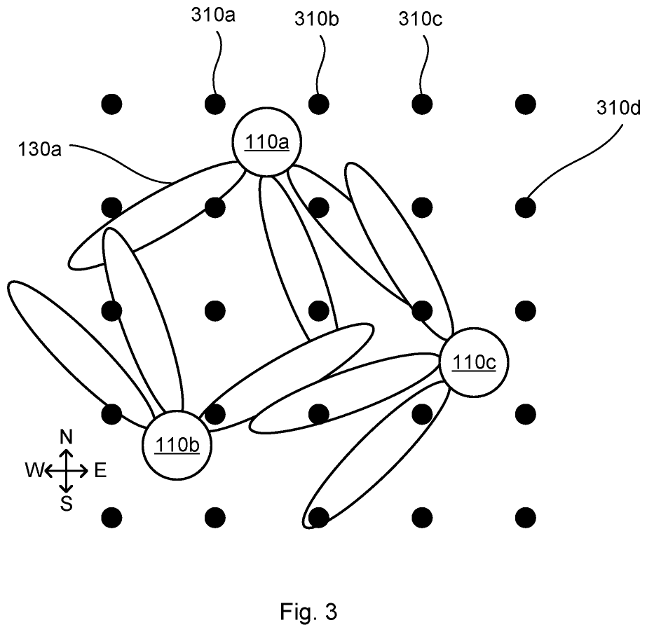

FIG. 2: schematically illustrates a side view of beamformed transmission from access point 110a towards user equipment 140a. The transmission is made from antenna system 120a located at horizontal plane 190a. The transmission is beamformed, where the transmission beam is represented by a main lobe 130a, aimed towards the user equipment 140, and four side lobes, or grating lobes, 130a-1, 130a-2, 130a-3, 130a-4. The height at which antenna system 120a is located with respect to the ground level 190b is marked at h. The height h thus extends between the ground level 190b and the horizontal plane 190a. In FIG. 2 is further at seven dots schematically illustrated a set of grid points, three grid points of which are identified at reference numerals 310a, 310b, 310c. It can be noted that transmission in side lobe 130a-2 will reach grid point 310b.

FIG. 3: schematically illustrates a top view of beamformed transmission from access points 110a:110c. Some of the possible beams that each access point 110a:110c could use for the beamformed transmission is also shown, where one of the beams is identified at reference numeral 130a. As in FIG. 1, only the main lobe of each beam is illustrated. FIG. 3 also shows a set of 25 grid points, where four grid points are identified at reference numerals 310a, 310b, 310c, 310d. The grid points might be located in the same horizontal plane as the antenna systems of the access points 110a:110c and/or in a horizontal plane placed vertically above the antenna systems. Such placements of the grid points can be used to take into account that the victim might be moving at different heights over time. A compass rose indicates the directions of north (N), south (S), east (E), and west (W).

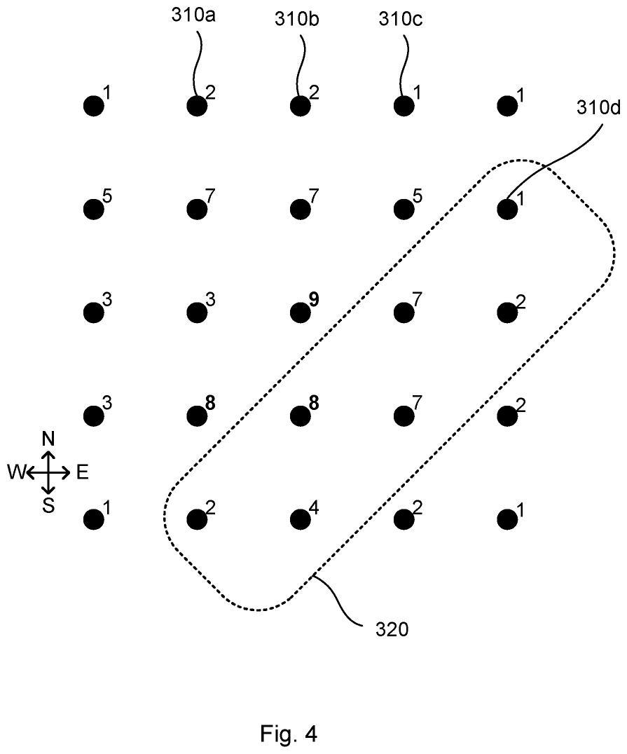

FIG. 4: schematically illustrates a top view of the same grid points as in FIG. 3. In FIG. 4 is by the numerical value placed next to each grid point further illustrated the aggregated interference per each of the grid points (for illustrative purposes assumed to take a value in the interval from 1 to 9). FIG. 4 further schematically illustrates a region of interest 320 overlaying some of the grid points. The region of interest 320 can therefore be defined by a subset of the grid points. In the illustrative example of FIG. 4, grid point 310d is part of this subset of the grid points.

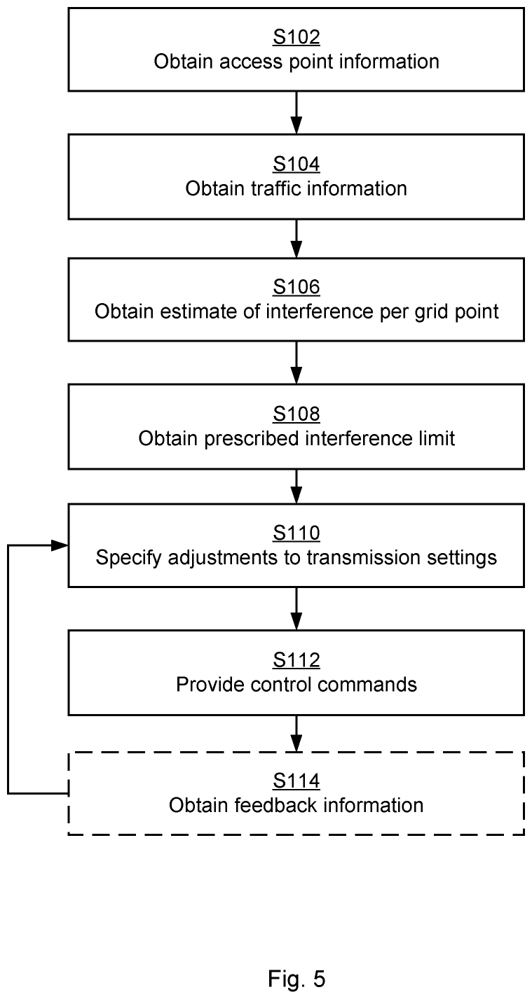

FIG. 5 is a flowchart illustrating embodiments of methods for interference-limited transmission from access points 110a:110c in a communication network 100. Each of the access points 110a:110c comprises an antenna system 120a:120c. The methods are performed by the control node 200. The methods are advantageously provided as computer programs 1020.

S102: The control node 200 obtains access point information indicative of geographical deployment information for the access points 110a:110c, and access point information indicative of transmission settings for the access points 110a:110c.

S104: The control node 200 obtains traffic information indicative of over-the-air (OTA) traffic patterns of the access points 110a:110c. The OTA traffic patterns comprise OTA transmission patterns and any scheduling requests for user equipment 140a:140f served by the access points 110a:110c.

S106: The control node 200 obtains an estimate of interference per each grid point 310a:310d in a set of geographically spread grid points 310a:310d and per each of the access points 110a:110c. The grid points 310a:310d are placed in line with and/or above a horizontal plane 190a of the antenna systems 120a:120c of the access points 110a:110c.

S108: The control node 200 obtains a prescribed interference limit for at least a subset of the grid points 310a:310d.

S110: The control node 200 specifies adjustments to the transmission settings of at least one of the access points 110a:110c based on an aggregate of the obtained estimates of interference for all the access points 110a:110c per each of the grid points 310a:310d. The adjustments are conditioned on the prescribed interference limit for said subset of the grid points 310a:310d and on the traffic information.

S112: The control node 200 provides control commands defined by the specified adjustments to the transmission settings towards said at least one of the access points 110a:110c.

Advantageously, this method provides improved interference suppression, or mitigation, in a communication network compared to the current technologies listed in the background section of the present disclosure.

Advantageously, this method removes the need for additional, or baseline, interference and/or power limits for the access points as the interference will be controlled and limited.

Advantageously, the proposed method is not limited to interference mitigation for stationary ground-based victims whose exact locations are known to the access points.

Advantageously, the use of grid points enables the accumulated interference towards a moving or stationary victims to be calculated without knowing the actual position of the victim.

Advantageously, this method allows for usage of the spectrum which otherwise is not useable due to strict protection requirements.

Advantageously, this method provides additional degrees of freedom with regards to parameters to be adjusted in comparison to techniques based on independently limiting the amount of power, or unwanted emissions, from each individual access point.

Advantageously, this method allows for less stringent requirement of unwanted emissions, or power restrictions, for individual access points towards the victim.

Advantageously, this method enables better utilization of the available headroom for adjusting emissions and/or power, thereby enabling improvements to throughput and/or user service quality in the communication network.

Advantageously, this method enables guard bands to be reduced, thereby increasing spectrum efficiency.

Advantageously, this method enables the size of interference controlled zones (e.g., around airports) to be reduced.

Advantageously, this method can be used as part of optimizing the power usage of the access points whilst still meeting interference conditions.

According to this method, a set of geographically spread grid points 310a:310d is defined which can be considered to represent an interference grid with fictive fixed points for the accumulated interference at the horizon and/or above horizon with respect to the antenna systems 120a:120c. An aggregate of the obtained estimates of interference for all the access points 110a:110c per each of the grid points 310a:310d is then formed and compared to a prescribed interference limit to protect possible victims, without the need to know their actual positions.

According to this method, the aggregated interference for a set of access points 110a:110c can be controlled with respect to a prescribed interference limit at the geographically spread grid points 310a:310d.

The subset of the grid points 310a:310d corresponds to the possible locations of the victim. However, this does not imply that a victim always has a location that corresponds to that of the subset of the grid points 310a:310d. The latter could be the case where the subset of the grid points 310a:310d defines an area, such as a final approach path, in the vicinity of an airport.

The accumulated interference from all the access points can be calculated per each of the grid points based on assuming line of sight (LOS) conditions (and calculating the associated pathloss) and for a given antenna radiation pattern (including sidelobes). The antenna radiation pattern can be determined analytically based on knowledge of the antenna system or using a lookup table containing details of the antenna radiation patterns for a set of beam steering directions. The instantaneous traffic situation in the network is known (from scheduling requests) and can be managed to control the actual caused interference over time.

According to this method, the worst case interference aggregation towards a victim can be avoided. That is, simultaneous maximum transmission towards a potential victim can be avoided. With this, the individual requirements per each access point (for 100% victim protection) can be relaxed by about 4 dB in the following example:

10·log₁₀(number of access points in area causing interference to victim)−10·log₁₀(number of access points causing time/space scheduled interference))

The above example is for one position of the victim, but the same calculation can be made at the same time for other possible positions of victim. The calculations are limited to the above-defined grid points.

Details relating to the geographical deployment information will be disclosed next.

In some non-limiting examples, the geographical deployment information per each of the access points 110a:110c specifies any of: vertical height (h) of the antenna system 120a:120c, orientation of the antenna system 120a:120c, direction of the antenna system 120a:120c, mechanical tilt capability of the antenna system 120a:120c, geographical placement of the antenna system 120a:120c, etc.

Details relating to the transmission settings for the access points 110a:110c will be disclosed next.

In some examples, information of the location of each access point 110a:110c and information of the performance of the antenna systems 120a:120c (in terms of which parameters that can be set/tuned to limit interference at different moments in time) is obtained by the control node 200. In some non-limiting examples, the transmission settings specify any of: antenna system configurations, antenna radiation patterns, transmission power level, per each of the antenna systems 120a:120c, etc. Yet further transmission settings might specify the number of antenna elements per antenna system (or sub-array), the size of each antenna system, the element separation, i.e., the distance between adjacent antenna elements, of each antenna system, etc. In some non-limiting examples, the access point information is obtained from one or more look-up tables in a database 170. Based on at least some of the transmission settings, the power in any specific direction can be estimated, or calculated, and stored in the database 170 and then access by the control node 200 (or even estimated, or calculated, by the control node 200 itself). In general, the control node 200, or some other node, needs to estimate, or calculate, the resulting antenna radiation pattern for the scheduled beam directions per each of the access points in order to be able to estimate radiated power per access point in a given direction, or at a given location, where the level of interference is to be controlled. This information can be pre-calculated and stored in a look up table in the database 170. For a given set of beam directions, the aggregated transmission power, corresponding to the aggregated interference, for all the access points can then be calculated for a specific grid point by aggregating the radiated power per access point. This means that for each time instant under consideration the control node 200 can obtain an estimate of the total aggregated interference in a specific location, such as given by the grid points. The control node 200 can thus utilize this information to predict the aggregated interference towards a specific victim. If the transmission settings are now known at the control node 200, then the control node 200 may need to make worst case assumptions on the radiation towards the victim and then only manage activation and power level of each access point 110a:110c.

Details relating to the traffic information will be disclosed next.

As disclosed above, the traffic information is indicative of OTA traffic patterns of the access points 110a:110c. In some non-limiting examples, the traffic information further is indicative of the total amount of OTA traffic servable per each of the access points 110a:110c. In some non-limiting examples, the traffic information further is indicative of locations of the user equipment 140a:140f served by the access points 110a:110c. In some embodiments, the traffic information is obtained as live data from the access points 110a:110c and/or from the centralized scheduler 160 of the access points 110a:110c. This enables the interference caused by each access point for a given grid point to be predicted. In some embodiments, the estimates of interference for all the grid points 310a:310d are a function of the traffic information.

Further, with respect to the OTA transmission patterns, the OTA transmission patterns describe how (such as when in time, frequency, and/or space) signals are sent in the downlink towards the user equipment 140a:140f served by the access points 110a:110c. The OTA transmission patterns might thus be regarded as capturing time aspects, frequency aspects and spatial aspects of the signals sent in the downlink towards the user equipment 140a:140f served by the access points 110a:110c. More generally, the OTA transmission patterns might refer to both radiation characteristics and time/frequency allocation. Thus, in summary, the OTA transmission pattern for a given access point 110a:110c might represents the resources in a time/frequency/space grid used by the given access point 110a:110c.

Based on the available transmission settings and the traffic information, certain combinations of transmission setting combinations for the different access points (such as different combinations of beam directions for different access points, which user equipment to be served by which access point, and/or which output power level to be used by each access point) which would exceed the interference at the grid points of interest can be identified and marked as not allowable.

Details relating to the scheduling requests will be disclosed next.

There could be different information included in, or conveyed by, the scheduling requests. In some non-limiting examples, the scheduling requests are indicative of any of: amount of data scheduled for the user equipment 140a:140f, priority levels for the data scheduled for the user equipment 140a:140f, and priority levels for the user equipment 140a:140f. For example, an access point serving high-priority user equipment or user equipment with high-priority data might be allowed to create a greater amount of interference at some grid points, compensated for by another access point being denied from creating interference in those directions. Further in this respect, it is noted that the control node 200 might not have access to all scheduling requests being issued in the communication network 100. In particular, in some embodiments, the scheduling requests are a subset of all scheduling requests made by the access points 110a:110c. The subset of all scheduling requests consists of the scheduling requests that are reported to the control node 200 by the access points 110a:110c or the centralized scheduler 160 of the access points 110a:110c. That is, the scheduling requests in S104 might be defined by those scheduling requests that are known to control node 200 by being reported to the control node 200 by the access points 110a:110c or the centralized scheduler 160.

In summary, in some examples, the interference per each grid point 310a:310d in the set of geographically spread grid points 310a:310d and per each of the access points 110a:110c might be estimated based on at least some of the following parameters (given in no particular order with respect to relevance or availability): maximum output power of each access point 110a:110c, intended output power of each access point 110a:110c, traffic situation per of each access point 110a:110c (e.g. in terms of which and/or how many user equipment each access point 110a:110c needs to serve), relative directions between serving access points 110a:110c and served user equipment, beam directions, or settings, available to each access point 110a:110c, beam directions, or settings, intended to be used by each access point 110a:110c, location of each user equipment to be served, location of each access point 110a:110c, antenna system, antenna system configurations, and antenna radiation pattern for each antenna system configuration.

As a non-limiting illustrative example, the aggregated power can be expressed in terms of EIRL, defined as EIRL=EIRP−L, where L is free space path loss and EIRP is the Equivalent Isotropic Radiated Power, for each grid point. The aggregated power for a grid grid point p can be calculated as EIRL_p=EIRL_p1+EIRL_p2+ . . . EIRL_pN, where EIRL_pn is the contribution to EIRL_p from access point n, where thus EIRL_pn=EIRP_pn−L_pn, where L_pn is the propagation loss between grid point p and access point n. L_pn can be calculated as the free space path loss based on the distance between access point n and grid point p if interference towards the sky is considered.

Details relating to the set of geographically spread grid points 310a:310d will be disclosed next.

In some examples, the geographic spread of the grid points 310a:310d is limited to possible positions of the victim. Particularly, in some embodiments, the subset of the grid points 310a:310d is defined according to one or more regions of interest 320 where interference to at least one victim radio transceiver, or receiver, device 180 is to be avoided. This information might by the control node 200 be used to determine not only where to place the grid points 310a:310d but also to determine for which access points 110a:110c interference-limited transmission is to be controlled; interference-limited transmission needs only to be considered for those access points 110a:110c affecting the interference in the grid points 310a:310d of interest.

Further, in some examples, the grid size, location of the grid points 310a:310d, spacing between the grid points 310a:310d, etc. depends on the type of victim (e.g., if the victim is a satellite, an airplane, etc.) as well as the density of the access points 110a:110c. Thus, in some non-limiting examples, any of: locations of the grid points 310a:310d, number of grid points 310a:310d, spacing between adjacent grid points 310a:310d depends on any of: number of access points 110a:110c, spacing between adjacent access points 110a:110c, and type of the at least one victim radio transceiver, or receiver, device 180, etc. This information could be obtained by the control node 200 from the database 170.

As an illustrative example, as victims generally are located in the sky, and the fact that there might be many victims with changing positions over time, the subset of the grid points is selected to mimic the average, expected, or average, movement of the victims over time. For example, as disclosed above, the subset of the grid points 310a:310d might define an area, such as a final approach path, in the vicinity of an airport. Even though there, for a certain given point in time, there are no victims in this area, it can be assume that victims, in the terms of airplanes, will pass this area on their decent towards the runway. Hence, if flight routes with positions where interference mitigation is critical, are known, this information can be used to define the subset of the grid points, and/or to reduce the total number of grid points.

Details relating to how the adjustments to the transmission settings might be specified will be disclosed next.

In general terms, the estimate of interference per each grid point 310a:310d for the access points 110a:110c are obtained for some given transmission settings for each of the access points. These given transmission settings generally are those transmission settings that are to be used for the scheduling requests to be fulfilled. Hence, in some embodiments, the estimate of interference per each grid point 310a:310d for the access points 110a:110c are obtained for a proposed set of transmission settings for fulfilling the scheduling requests, and the adjustments to the transmission settings are specified in relation to the proposed set of transmission settings.

Further, as disclosed above, the adjustments are conditioned on the prescribed interference limit for a subset of the grid points 310a:310d. This means that the transmission settings are adjusted so that the prescribed interference limit for the subset of the grid points 310a:310d is not exceeded. Hence, in some embodiments, the adjustments to the transmission settings are specified subject to that the aggregate of the obtained estimate of interference per each grid point in the subset of the grid points 310a:310d does not exceed the prescribed interference limit.

Further in this respect, the prescribed interference limit might be defined by an average interference level within a time window. In this case, although the intravenous aggregated interference might exceed the prescribed interference limit, the aggregated interference as averaged over the time window is controlled to never exceed the prescribed interference limit. The time window might be relatively short, such as in the order of minutes, or even seconds. Alternatively, the time window might be relatively long, such as in the order of hours, or even months.

There might be further conditions according to which the adjustments to the transmission settings are specified. In general terms, good cellular performance for the user equipment served by the access points should be considered. Therefore, in some aspects, the adjustments to the transmission settings are specified with an object to fulfill the scheduling requests. Hence, in some embodiments, the adjustments to the transmission settings are specified subject to that the scheduling requests are fulfilled.

There could be different ways in which the transmission settings can be adjusted. In non-limiting examples, the adjustments to the transmission settings pertain to any of: power back off level, antenna radiation pattern shaping or restriction, for the antenna system 120a:120c of the at least one of the access points 110a:110c.

The control node 200 might thereby inform the access points of allowed transmission power, beam direction for serving user equipment, etc. in order not to exceed a maximum allowed interference towards the victim. Non-limiting examples of how the sidelobe direction for a single access point over space and time can be controlled will be disclosed next.

According to a first example, the adjustment of the transmission settings cause one or more of the access points to reduce total power in a given direction, for example using power back-off or selecting a beam which generates less interference.

According to a second example, the adjustment of the transmission settings cause one or more of the access points to use beams where the pointing direction of the main beam is not towards the served user equipment, but rather where one or more of the side-lobes are used to provide network coverage for the user equipment.

According to a third example, the adjustment of the transmission settings cause one or more of the access points to apply excitation amplitude/phase tapering. With amplitude tapering the side lobes can be suppressed, but also the maximum gain towards the served user equipment has a penalty. Further details relating to this example will be disclosed below.

According to a fourth example, the adjustment of the transmission settings cause one or more of the access points to apply null-steering in the direction towards the victim.

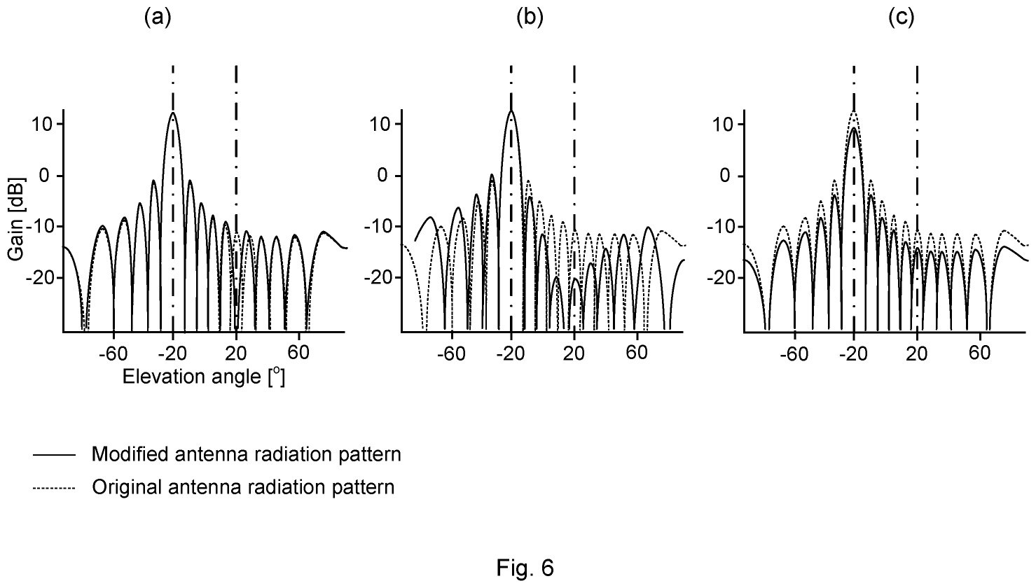

Intermediate reference is here made to FIG. 6. In FIG. 6 is illustrated three examples of how transmission settings might be adjusted for interference mitigation. In each of the figures an access point is serving a user equipment in the vicinity of a victim. The user equipment is located in a direction of 20° below the horizon of the access point and the victim is located in a direction of 20° above the horizon of the access point. In FIG. 6(a) is illustrated an example where null-steering towards the horizon is applied at the access point. The figure shows the antenna radiation pattern before and after null-steering. As can be seen, application of the null-steering causes the interference in the direction towards the victim to be reduced. In FIG. 6(b) is illustrated an example where amplitude tapering is applied at the access point. The figure shows the antenna radiation pattern before and after amplitude tapering. As can be seen, application of the amplitude tapering causes the interference in the direction towards the victim to be reduced. In FIG. 6(c) is illustrated an example where power back-off is applied at the access point. The figure shows the antenna radiation pattern before and after power back-off having been applied. As can be seen, application of the power back-off causes the interference in the direction towards the victim to be reduced. In comparison, according to the examples in FIG. 6, null-steering yields best results whilst power back-off yields worst results with respect to reducing the interference caused towards the victim.

According to a fifth example, the adjustment of the transmission settings cause one or more of the access points to make a reselection of which user equipment to be served over time. In general terms, the centralized scheduler 160 might control which user equipment and when in time a given user equipment is to be served. Based on the control commands provided by the control node 200, the centralized scheduler 160 might therefore also have to consider the overall network interference aspect.

In some aspects, interference-limited transmission is only initiated, or triggered, if the aggregated interference exceeds the prescribed interference limit. That is, in some examples, the aggregate of the obtained estimates of interference for all the access points 110a:110c per at least one grid point in the subset of the grid point 310a:310d exceeds the prescribed interference limit unless the transmission settings of the at least one of the access points 110a:110c are adjusted.

The control node 200 might receive various types of feedback from any entity in the communication network, such any of the access points 110a:110c, the centralized scheduler 160 or even the victim. Therefore, in some embodiments, the control node 200 is configured to perform (optional) step S114.

S114: The control node 200 obtains feedback information of actual aggregated interference caused by the access points 110a:110c upon the specified adjustments having been made to the transmission settings.

This feedback information can by the control node 200 be used to further optimize the estimation of the accumulated interference at the grid points 310a:310d. The method can then be repeated, taking the feedback into consideration when making further adjustments to the transmission settings. Hence, in some embodiments, the method is repeatedly performed per time unit, and the feedback information obtained for one time unit is used when specifying the adjustments to the transmission settings in a next occurring time unit.

Further details of the control node 200 will be disclosed next. In general terms, the control node 200 might be configured for either centralized or decentralized operation.

When configured for centralized operation, the control node 200 is provided as a central entity that controls at least some aspects of the operation of the access points 110a:110c in a central manner. In this way the control node 200 might provide control commands pertaining to transmission settings in terms of allowed output power, activity level and beamforming restrictions, taking into account budgets on the power or unwanted emissions over a certain area and for a given set of access points. For this case the required information needed for the control node 200 to specify adjustments to the transmission settings is made available to the control node 200.

When configured for decentralized operation, the functionality of the control node 200 is distributed between at least some of the access points themselves. In this way, the required information needed for the control node 200 to specify adjustments to the transmission settings is exchanged between the access points in which the functionality of the control node 200 is implemented. This removes the need for having a dedicated separate entity, or device, in which the functionality of the control node 200 is implemented. The access points in which the functionality of the control node 200 is implemented are thereby made aware of the activity and actions of neighboring access points as well as the total limit on allowed interference and can thereby adjust their current transmission settings for the interference-limited transmission to take place. This requires that there is an interface, such as the X2 interface, connecting the access points for the information to be shared. This also requires that each access point is trusted to exchange the information with other access points, and that there is a protocol in place that dictates how the information is to be distributed among the access points. This also requires that the access points are capable of negotiating which of the access points should have priority for available resources.

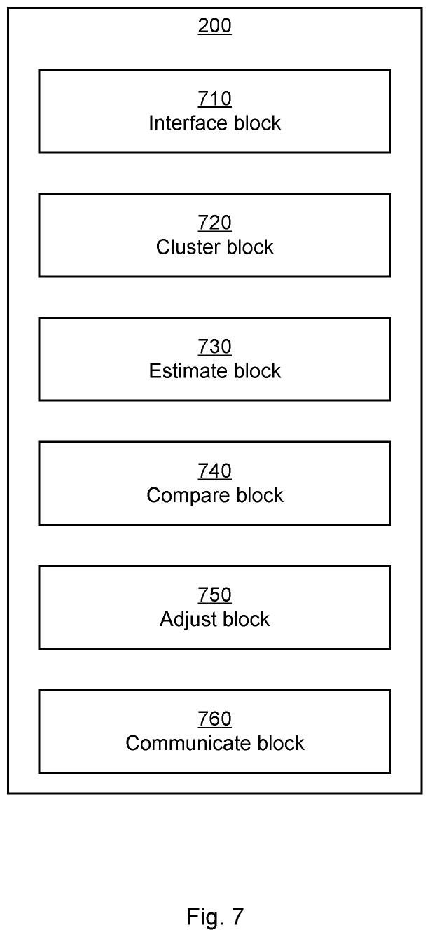

Reference is next made to FIG. 7 which shows a block diagram of the control node 200 according to an embodiment.

An interface block 710 is configured to interface with various sources of information to access information, such as access point information, traffic information, prescribed interference limit, location of victim, feedback information, etc. The interface block 710 might be activated at network deployment but can be activated during operation to be updated to reflect optimizations and changes in the communication network.

A cluster block 720 is configured to select a set of access points for which interference-limited transmission is to be performed to allow optimized operation within the communication network 100 and with respect to protection of the victim service. The selection can be made on the basis of the access points that contribute most to the interference towards the victim. These access points might have the lowest pathloss towards the victim.

An estimate block 730 is configured to estimate the aggregated interference per each grid point 310a:310d in a set of geographically spread grid points 310a:310d for the access points 110a:110c as disclosed above.

A compare block 740 is configured to compare the aggregated interference for a subset of the grid points 310a:310d to a prescribed interference limit.

An adjust block 750 is configured to control the interference for at least some of the access points based on the comparison to never allow for the worst case of simultaneously aggregated interference from the subset of the access points to occur towards the victim.

A communicate block 760 is configured to provide control commands defined by the specified adjustments to the transmission settings towards the access points.

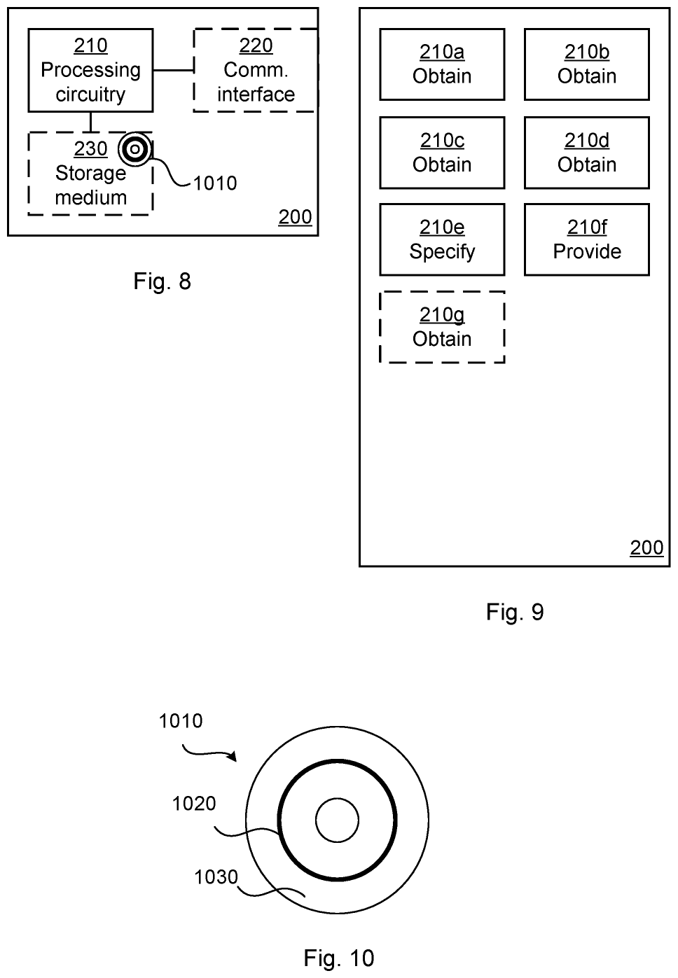

FIG. 8 schematically illustrates, in terms of a number of functional units, the components of a control node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1010 (as in FIG. 10), e.g. in the form of a storage medium 230. The processing circuitry 210 may further be provided as at least one application specific integrated circuit (ASIC), or field programmable gate array (FPGA).

Particularly, the processing circuitry 210 is configured to cause the control node 200 to perform a set of operations, or steps, as disclosed above. For example, the storage medium 230 may store the set of operations, and the processing circuitry 210 may be configured to retrieve the set of operations from the storage medium 230 to cause the control node 200 to perform the set of operations. The set of operations may be provided as a set of executable instructions.

Thus the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. The control node 200 may further comprise a communications interface 220 at least configured for communications with other entities, functions, nodes, and devices, as for example illustrated in the example of FIG. 1. As such the communications interface 220 may comprise one or more transmitters and receivers, comprising analogue and digital components. The processing circuitry 210 controls the general operation of the control node 200 e.g. by sending data and control signals to the communications interface 220 and the storage medium 230, by receiving data and reports from the communications interface 220, and by retrieving data and instructions from the storage medium 230. Other components, as well as the related functionality, of the control node 200 are omitted in order not to obscure the concepts presented herein.

FIG. 9 schematically illustrates, in terms of a number of functional modules, the components of a control node 200 according to an embodiment. The control node 200 of FIG. 9 comprises a number of functional modules; an obtain module 210a configured to perform step S102, an obtain module 210b configured to perform step S104, an obtain module 210c configured to perform step S106, an obtain module 210d configured to perform step S108, a specify module 210e configured to perform step S110, and a provide module 210f configured to perform step S112.

The control node 200 of FIG. 9 may further comprise a number of optional functional modules, such as an obtain module 210g configured to perform step S114g. In general terms, each functional module 210a:210g may in one embodiment be implemented only in hardware and in another embodiment with the help of software, i.e., the latter embodiment having computer program instructions stored on the storage medium 230 which when run on the processing circuitry makes the control node 200 perform the corresponding steps mentioned above in conjunction with FIG. 9. It should also be mentioned that even though the modules correspond to parts of a computer program, they do not need to be separate modules therein, but the way in which they are implemented in software is dependent on the programming language used. Preferably, one or more or all functional modules 210a:210g may be implemented by the processing circuitry 210, possibly in cooperation with the communications interface 220 and/or the storage medium 230. The processing circuitry 210 may thus be configured to from the storage medium 230 fetch instructions as provided by a functional module 210a:210g and to execute these instructions, thereby performing any steps as disclosed herein.

The control node 200 may be provided as a standalone device or as a part of at least one further device. For example, the control node 200 may be provided in a node of the radio access network or in a node of the core network. Alternatively, functionality of the control node 200 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time. Thus, a first portion of the instructions performed by the control node 200 may be executed in a first device, and a second portion of the of the instructions performed by the control node 200 may be executed in a second device; the herein disclosed embodiments are not limited to any particular number of devices on which the instructions performed by the control node 200 may be executed. Hence, the methods according to the herein disclosed embodiments are suitable to be performed by a control node 200 residing in a cloud computational environment. Therefore, although a single processing circuitry 210 is illustrated in FIG. 8 the processing circuitry 210 may be distributed among a plurality of devices, or nodes. The same applies to the functional modules 210a:210g of FIG. 9 and the computer program 1020 of FIG. 10.

FIG. 10 shows one example of a computer program product 1010 comprising computer readable storage medium 1030. On this computer readable storage medium 1030, a computer program 1020 can be stored, which computer program 1020 can cause the processing circuitry 210 and thereto operatively coupled entities and devices, such as the communications interface 220 and the storage medium 230, to execute methods according to embodiments described herein. The computer program 1020 and/or computer program product 1010 may thus provide means for performing any steps as herein disclosed.

In the example of FIG. 10, the computer program product 1010 is illustrated as an optical disc, such as a CD (compact disc) or a DVD (digital versatile disc) or a Blu-Ray disc. The computer program product 1010 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1020 is here schematically shown as a track on the depicted optical disk, the computer program 1020 can be stored in any way which is suitable for the computer program product 1010.

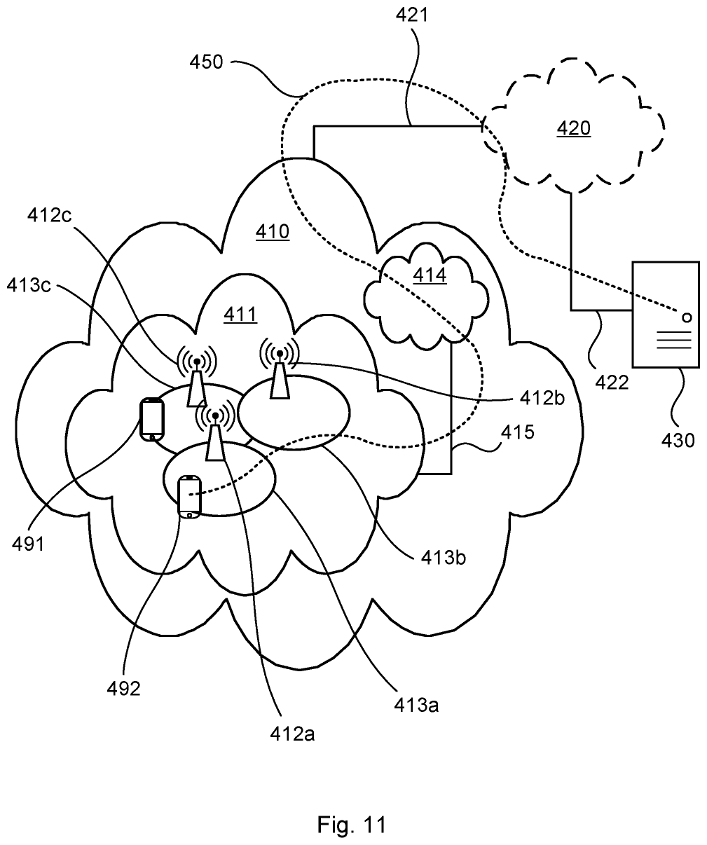

FIG. 11 is a schematic diagram illustrating a telecommunication network connected via an intermediate network 420 to a host computer 430 in accordance with some embodiments. In accordance with an embodiment, a communication system includes telecommunication network 410, such as a 3GPP-type cellular network, which comprises access network 411, and core network 414. Access network 411 comprises a plurality of radio access network nodes 412a, 412b, 412c, such as NBs, eNBs, gNBs (each corresponding to the access points 110a:110c of FIG. 1) or other types of wireless access points, each defining a corresponding coverage area, or cell, 413a, 413b, 413c. Each radio access network nodes 412a, 412b, 412c is connectable to core network 414 over a wired or wireless connection 415. A first UE 491 located in coverage area 413c is configured to wirelessly connect to, or be paged by, the corresponding network node 412c. A second UE 492 in coverage area 413a is wirelessly connectable to the corresponding network node 412a. While a plurality of UE 491, 492 are illustrated in this example, the disclosed embodiments are equally applicable to a situation where a sole UE is in the coverage area or where a sole terminal device is connecting to the corresponding network node 412. The UEs 491, 492 correspond to the user equipment 140a:140f of FIG. 1.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider, or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 11 as a whole enables connectivity between the connected UEs 491, 492 and host computer 430. The connectivity may be described as an over-the-top (OTT) connection 450. Host computer 430 and the connected UEs 491, 492 are configured to communicate data and/or signalling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, network node 412 may not or need not be informed about the past routing of an incoming downlink communication with data originating from host computer 430 to be forwarded (e.g., handed over) to a connected UE 491. Similarly, network node 412 need not be aware of the future routing of an outgoing uplink communication originating from the UE 491 towards the host computer 430.

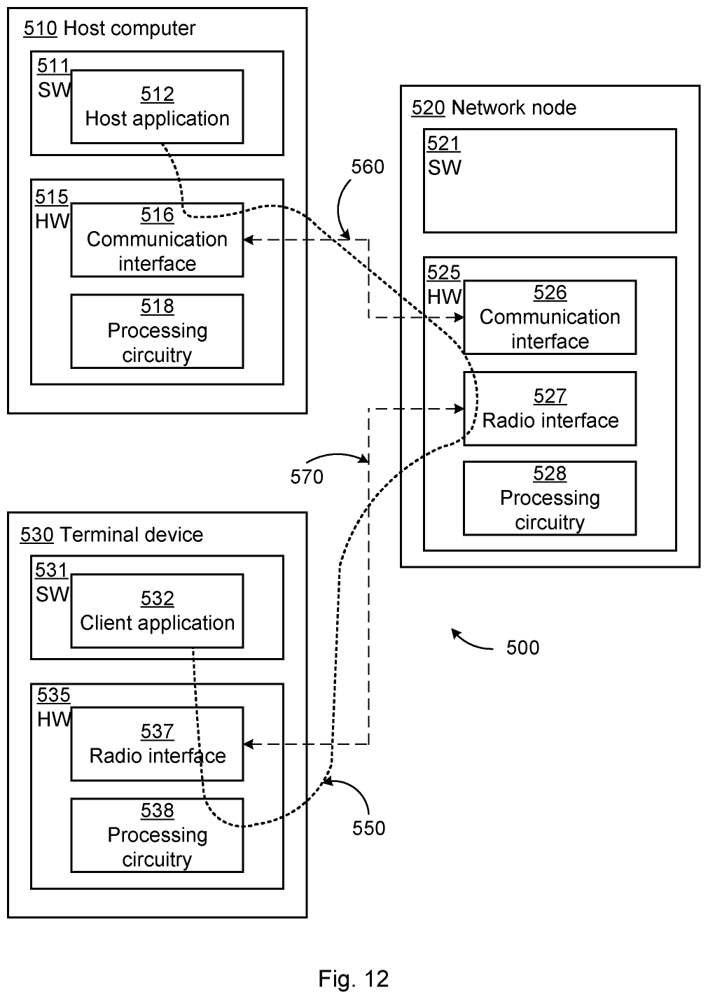

FIG. 12 is a schematic diagram illustrating host computer communicating via a radio access network node with a UE over a partially wireless connection in accordance with some embodiments. Example implementations, in accordance with an embodiment, of the UE, radio access network node and host computer discussed in the preceding paragraphs will now be described with reference to FIG. 12. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. The UE 530 corresponds to the user equipment 140a:140f of FIG. 1. In providing the service to the remote user, host application 512 may provide user data which is transmitted using OTT connection 550.

Communication system 500 further includes radio access network node 520 provided in a telecommunication system and comprising hardware 525 enabling it to communicate with host computer 510 and with UE 530. The radio access network node 520 corresponds to the access points 110a:110c of FIG. 1. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 12) served by radio access network node 520. Communication interface 526 may be configured to facilitate connection 560 to host computer 510. Connection 560 may be direct or it may pass through a core network (not shown in FIG. 12) of the telecommunication system and/or through one or more intermediate networks outside the telecommunication system. In the embodiment shown, hardware 525 of radio access network node 520 further includes processing circuitry 528, which may comprise one or more programmable processors, application-specific integrated circuits, field programmable gate arrays or combinations of these (not shown) adapted to execute instructions. Radio access network node 520 further has software 521 stored internally or accessible via an external connection.

Communication system 500 further includes UE 530 already referred to. Its hardware 535 may include radio interface 537 configured to set up and maintain wireless connection 570 with a radio access network node serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, radio access network node 520 and UE 530 illustrated in FIG. 12 may be similar or identical to host computer 430, one of network nodes 412a, 412b, 412c and one of UEs 491, 492 of FIG. 11, respectively. This is to say, the inner workings of these entities may be as shown in FIG. 12 and independently, the surrounding network topology may be that of FIG. 11.

In FIG. 12, OTT connection 550 has been drawn abstractly to illustrate the communication between host computer 510 and UE 530 via network node 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and radio access network node 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may reduce interference, due to improved classification ability of airborne UEs which can generate significant interference.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above, or supplying values of other physical quantities from which software 511, 531 may compute or estimate the monitored quantities. The reconfiguring of OTT connection 550 may include message format, retransmission settings, preferred routing etc.; the reconfiguring need not affect network node 520, and it may be unknown or imperceptible to radio access network node 520. Such procedures and functionalities may be known and practiced in the art. In certain embodiments, measurements may involve proprietary UE signalling facilitating host computer's 510 measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for interference-limited transmission from access points in a communication network, wherein each of the access points comprises an antenna system, wherein the method is performed by a control node, and wherein the method comprises:
obtaining access point information indicative of: geographical deployment information for the access points, and transmission settings for the access points;
obtaining traffic information indicative of over-the-air, OTA, traffic patterns of the access points, the OTA traffic patterns comprising OTA transmission patterns and any scheduling requests for user equipment served by the access points;
obtaining an estimate of interference per each grid point in a set of geographically spread grid points for the access points, wherein the grid points are in line with and/or above a horizontal plane of the antenna systems of the access points;
obtaining a prescribed interference limit for at least a subset of the grid points;
specifying adjustments to the transmission settings of at least one of the access points based on an aggregate of the obtained estimates of interference for all the access points per each of the grid points, wherein the adjustments are conditioned on the prescribed interference limit for said subset of the grid points and on the traffic information; and
providing control commands defined by the specified adjustments to the transmission settings towards said at least one of the access points.

2. The method according to claim 1, wherein the geographical deployment information specifies any of: vertical height (h), orientation, direction, mechanical tilt capability, and geographical placement of the antenna systems.

3. The method according to claim 1, wherein the transmission settings specify any of: antenna system configurations, antenna radiation patterns, and transmission power level, per each of the antenna systems.

4. The method according to claim 1, wherein the access point information is obtained from one or more look-up tables in a database.

5. The method according to claim 1, wherein the scheduling requests are indicative of any of: amount of data scheduled for the user equipment, priority levels for the data scheduled for the user equipment, and priority levels for the user equipment.

6. The method according to claim 1, wherein the traffic information further is indicative of any of: total amount of OTA traffic servable per each of the access points, and locations of the user equipment served by the access points.

7. (canceled)

8. The method according to claim 1, wherein the traffic information is obtained as live data from the access points or from a centralized scheduler of the access points.

9. The method according to claim 1, wherein the scheduling requests are a subset of all scheduling requests made by the access points, and wherein the subset of all scheduling requests comprises the scheduling requests that are reported to the control node by the access points or a centralized scheduler of the access points.

10. The method according to claim 1, wherein said subset of the grid points is defined according to one or more regions of interest where interference to at least one victim radio transceiver, or receiver, device is to be avoided.

11. The method according to claim 10, wherein any of: locations of the grid points, number of grid points, spacing between adjacent grid points depends on any of: number of access points, spacing between adjacent access points, and type of the at least one victim radio transceiver, or receiver, device.

12. The method according to claim 1, wherein the estimate of interference per each grid point for the access points are obtained for a proposed set of transmission settings for fulfilling the scheduling requests, and wherein the adjustments to the transmission settings are specified in relation to the proposed set of transmission settings.

13. The method according to claim 1, wherein the estimates of interference for all the grid points are a function of the traffic information, and wherein the adjustments to the transmission settings are specified subject to that the aggregate of the obtained estimate of interference per each grid point in said subset of the grid points does not exceed the prescribed interference limit.

14. (canceled)

15. The method according to claim 1, wherein the adjustments to the transmission settings are specified subject to that the scheduling requests are fulfilled.

16. The method according to claim 1, wherein the prescribed interference limit is defined by an average interference level within a time window, and wherein the aggregate of the obtained estimates of interference for all the access points per at least one grid point in said subset of the grid point exceeds the prescribed interference limit unless the transmission settings of said at least one of the access points are adjusted.

17. (canceled)

18. The method according to claim 1, wherein the adjustments to the transmission settings pertain to any of: power back off level, antenna radiation pattern shaping or restriction, for the antenna systems of said at least one of the access points.

19. The method according to claim 1, wherein the method further comprises:
obtaining feedback information of actual aggregated interference caused by the access points upon the specified adjustments having been made to the transmission settings.

20. The method according to claim 19, wherein the method is repeatedly performed per time unit, and wherein the feedback information obtained for one time unit is used when specifying the adjustments to the transmission settings in a next occurring time unit.

21. A control node for interference-limited transmission from access points in a communication network, wherein each of the access points comprises an antenna system, the control node comprising processing circuitry, the processing circuitry being configured to cause the control node to:
obtain access point information indicative of: geographical deployment information for the access points, and transmission settings for the access points;
obtain traffic information indicative of over-the-air, OTA, traffic patterns of the access points, the OTA traffic patterns comprising OTA transmission patterns and any scheduling requests for user equipment served by the access points;
obtain an estimate of interference per each grid point in a set of geographically spread grid points for the access points, wherein the grid points are in line with and/or above a horizontal plane of the antenna systems of the access points;
obtain a prescribed interference limit for at least a subset of the grid points;
specify adjustments to the transmission settings of at least one of the access points based on an aggregate of the obtained estimates of interference for all the access points per each of the grid points, wherein the adjustments are conditioned on the prescribed interference limit for said subset of the grid points and on the traffic information; and
provide control commands defined by the specified adjustments to the transmission settings towards said at least one of the access points.

22. A control node for interference-limited transmission from access points in a communication network, wherein each of the access points comprises an antenna system, the control node comprising:
an obtain module configured to obtain access point information indicative of: geographical deployment information for the access points, and transmission settings for the access points;
an obtain module configured to obtain traffic information indicative of over-the-air, OTA, traffic patterns of the access points, the OTA traffic patterns comprising OTA transmission patterns and any scheduling requests for user equipment served by the access points;
an obtain module configured to obtain an estimate of interference per each grid point in a set of geographically spread grid points for the access points, wherein the grid points are in line with and/or above a horizontal plane of the antenna systems of the access points;
an obtain module configured to obtain a prescribed interference limit for at least a subset of the grid points;
a specify module configured to specify adjustments to the transmission settings of at least one of the access points based on an aggregate of the obtained estimates of interference for all the access points per each of the grid points, wherein the adjustments are conditioned on the prescribed interference limit for said subset of the grid points and on the traffic information; and
a provide module configured to provide control commands defined by the specified adjustments to the transmission settings towards said at least one of the access points.

23. (canceled)

24. A computer program product for interference-limited transmission from access points in a communication network, wherein each of the access points comprises an antenna system, the computer program product comprising a non-transitory computer-readable medium storing computer code which, when run on processing circuitry of a control node, causes the control node to:
obtain access point information indicative of: geographical deployment information for the access points, and transmission settings for the access points;
obtain traffic information indicative of over-the-air, OTA, traffic patterns of the access points, the OTA traffic patterns comprising OTA transmission patterns and any scheduling requests for user equipment served by the access points;
obtain an estimate of interference per each grid point in a set of geographically spread grid points for the access points, wherein the grid points are in line with and/or above a horizontal plane of the antenna systems of the access points;
obtain a prescribed interference limit for at least a subset of the grid points;
specify adjustments to the transmission settings of at least one of the access points based on an aggregate of the obtained estimates of interference for all the access points per each of the grid points, wherein the adjustments are conditioned on the prescribed interference limit for said subset of the grid points and on the traffic information; and
provide control commands defined by the specified adjustments to the transmission settings towards said at least one of the access points.

25. (canceled)
